(19) United States
(12) Patent Application Publication
(10) Pub. No.: US 2023/0106057 A1
(43) Pub. Date: Apr. 6, 2023

(54) POSITIVITY VALIDATION AND EXPLAINABILITY FOR CAUSAL INFERENCE VIA ASYMMETRICALLY PRUNED DECISION TREES

(71) Applicant: VIANAI SYSTEMS, INC., Palo Alto, CA (US)

(72) Inventors: Guy WOLF, Herzliya (IL); Gil SHABAT, Hod Hasharon (IL); Hanan SHTEINGART, Herzliya (IL)

(21) Appl. No.: 17/960,049

(22) Filed: Oct. 4, 2022

Related U.S. Application Data
(60) Provisional application No. 63/276,425, filed on Nov. 5, 2021.
(60) Provisional application No. 63/252,535, filed on Oct. 5, 2021.

(51) Int. Cl. G06N 20/00

(52) U.S. Cl. CPC G06N 20/00

(57) ABSTRACT

One embodiment of a computer-implemented method for detecting positivity violations within a dataset comprises generating, using a trained machine learning model, a plurality of propensity scores based on observational data associated with a group of entities; analyzing the plurality of propensity scores to identify one or more potential positivity violations; performing one or more training operations on the observational data based on the one or more potential positivity violations to generate a first trained decision tree associated with the one or more potential positivity violations; and determining, based on the trained first decision tree, a first positivity violation comprising a first combination of attribute values that is associated with at least one entity included in treatment group and is not associated with any entity included in a control group.

### CROSS-REFERENCE TO RELATED APPLICATIONS

This application claims the priority benefit of U.S. Provisional Application No. 63/252,535, tiled “POSITIVITY VALIDATION AND EXPLAINABILITY VIA ASYMMETRICALLY PRUNED DECISION TREES,” filed on Oct. 5, 2021, and U.S. Provisional Application No. 63/276,425, titled “POSITIVITY VALIDATION AND EXPLAINABILITY VIA ASYMMETRICALLY PRUNED DECISION TREES,” filed on Nov. 5, 2021, the subject matter which are incorporated by reference herein in its entirety.

### BACKGROUND

### Field of the Various Embodiments

The various embodiments relate generally to computer science and machine learning and, more specifically, to positivity validation and explainability for causal inference via asymmetrically pruned decision trees.

### Description of the Related Art

Causal inference is the process of analyzing observational data corresponding to a group of entities to determine whether applying a given action to entities within the group “causes” a change to a given outcome variable associated with the group of entities. The group of entities includes both entities to which the given action was applied (a “treatment group”) and entities to which the action was not applied (a “control group”). One or more entities in the treatment group are compared against one or more entities in the control group that have the same or similar attributes, characteristics, and/or other variable values. By comparing similar entities, the potential effect of attributes, characteristics, and other variables on the given outcome variable are reduced. For example, in the context of a video game, causal inference could be used to determine whether providing a reward to a player causes an increase in the amount of time the player interacts with the video game. To determine the effect of providing the reward on the amount of time that a player interacts with a game, if any, the players are divided into two groups: a first group of players that received the reward and a second group of players that did not receive the reward. The amount of time that players who received the reward interacts with the game is compared against the amount of time that similar players who did not receive the reward, interacts with the game to determine whether players that received the reward interacted with the game longer relative to similar players that did not receive the reward.

Because causal inference involves comparing similar entities, if an entity having a given combination of attribute values is included in one of the treatment group or the control group, then at least one entity having the given combination of attribute values must also be included in the other group. This requirement is referred to as “positivity.” In many cases, however, the entities to which an action is applied or is not applied cannot be controlled to ensure that similar entities are included in both the treatment group and the control group. As a result, positivity violations can occur, where only one group (e.g., treatment or control) includes entities associated with a given combination of attribute values. In such cases, causal inference cannot be properly performed using the corresponding set of observational data unless the data associated with the entities is removed from the set of data or additional data for corresponding entities in the other group is added to the set of data. Referring, again, to the above example, the first group of players could include female players whose average play time is more than 10 hours, while the second group of players does not include any female players whose average play time is more than 10 hours. Accordingly, the effect of providing the reward to female players whose average play time is more than 10 hours cannot be properly analyzed, because there were no female players whose average play time is more than 10 hours who did not receive the reward.

One approach commonly used to detect positivity violations in a set of data, if any, is to analyze each combination of attribute values included in the set of data to determine whether a given combination of attribute values is included in both a treatment group and a control group. However, many real-world data sets have “high dimensionality” and include large numbers of attributes. Analyzing all possible combinations of attribute values in high-dimensionality data requires large amounts of computing resources and can take excessively long amounts of time to complete. For example, data associated with a group of people could include attributes such as personal information (e.g., age, gender, location, education level, income level, marital status, household size, and/or the like), personal preferences (e.g., hobbies, interests, likes, dislikes, and/or the like), scenario-specific information (e.g., video game player information, marketing information, web browsing history, and/or the like), and so forth. Additionally, each attribute has multiple possible attribute values. Because the number of possible combinations would increase exponentially as the number of attributes increases, analyzing all possible combinations of attribute values for a set of data that includes a large number of attributes could involve performing billions of search and comparison operations on the set of data.

Another approach for detecting positivity violations is to compare the distribution of values for each attribute in the treatment group with the distribution of values for the attribute in the control group to identify differences between the distributions. Areas in which the distributions differ indicate an attribute value or a range of attribute values where a positivity violation could exist. However, this approach identifies only differences in the distribution of values for a single attribute and, therefore, detects only positivity violations in the single attribute. Because this approach cannot be used to determine when specific combinations of attributes are present in one group but not the other, this approach cannot be used to identify positivity violations by the specific combinations of attributes. Therefore, comparing attribute value distributions does not accurately identify positivity violations within a set of data.

As the foregoing illustrates, what is needed in the art are more effective techniques for detecting positivity violations within a dataset.

### SUMMARY

One embodiment of the present disclosure sets forth a computer-implemented method for detecting positivity violations within a dataset. The method includes generating, using a trained machine learning model, a plurality of propensity scores based on observational data associated with a group of entities, wherein, for each entity included in the group of entities, the observational data includes a plurality of attribute values associated with the entity, and wherein the group of entities comprises a subset of first entities that received a treatment and a subset of second entities that did not receive the treatment. The method further includes analyzing the plurality of propensity scores to identify one or more potential positivity violations. In addition, the method includes performing one or more training operations on the observational data based on the one or more potential positivity violations to generate a first trained decision tree associated with the one or more potential positivity violations, and determining, based on the trained first decision tree, a first positivity violation comprising a first combination of attribute values that is associated with at least one entity included in the subset of first entities and is not associated with any entity included in the subset of second entities.

At least one technical advantage of the disclosed techniques relative to the prior art is that, with the disclosed techniques, positivity violations are detected in a high-dimensionality dataset using less time and fewer computing resources relative to prior approaches. More specifically, by using a trained machine learning model to generate multiple propensity scores from a given dataset and then analyzing those propensity scores to detect positivity violations, the number of dimensions analyzed is reduced from multiple dimensions, equal to the number of attributes included in the given dataset, to a single dimension, the actual propensity scores. As a result, identifying positivity violations using the disclosed techniques can be substantially faster and can be accomplished using substantially fewer processing resources relative to conventional techniques. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments;

FIG. 2 is a conceptual diagram illustrating how positivity violations are detected and analyzed, according to various embodiments;

FIG. 3 is a more detailed illustration of the positivity analysis application of FIG. 1, according to various embodiments;

FIG. 4 is a more detailed illustration of the explainability application of FIG. 1, according to various embodiments;

FIG. 5 is a flow chart of method steps for detecting positivity violations using a trained machine learning model, according to various embodiments; and

FIG. 6 is a flow chart of method steps for generating positivity violation explanations based on one or more potential positivity violations, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

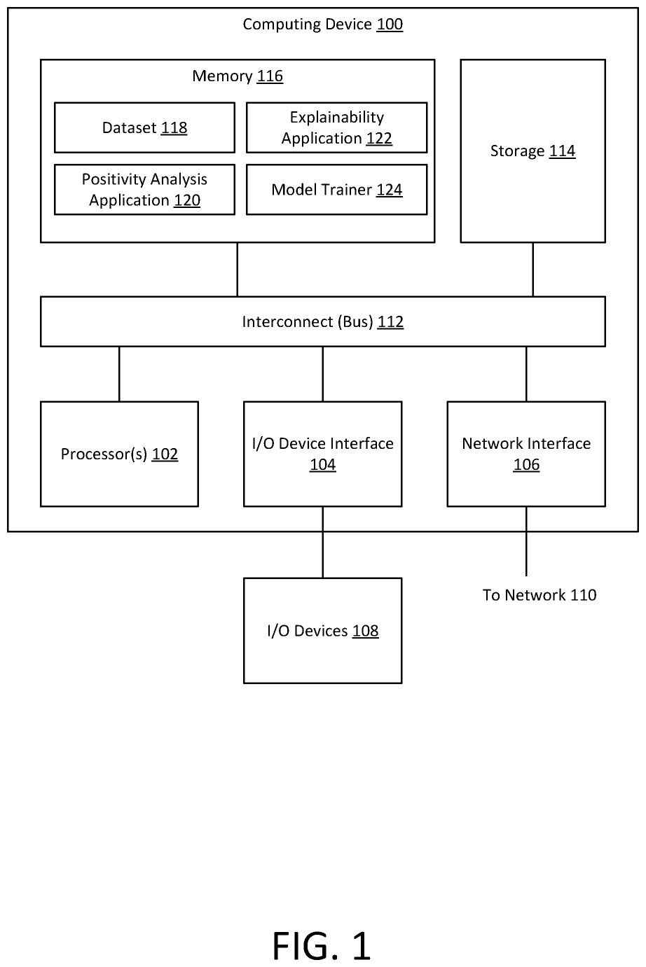

FIG. 1 illustrates a computing device 100 configured to implement one or more aspects of various embodiments. As shown, computing device 100 includes an interconnect (bus) 112 that connects one or more processing units 102, an input/output (I/O) device interface 104 coupled to one or more input/output (I/O) devices 108, memory 116, a storage 114, and a network interface 106.

Computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 described herein is illustrative and that any other technically feasible configurations fall within the scope of the present disclosure.

The one or more processing units 102 include any suitable processor implemented as a central processing unit (CPU), a graphics processing unit (GPU), an application-specific integrated circuit (ASIC), a field programmable gate array (FPGA), an artificial intelligence (Al) accelerator, any other type of processing unit, or a combination of different processing units, such as a CPU configured to operate in conjunction with a GPU. In general, a processing unit 102 can be any technically feasible hardware unit capable of processing data and/or executing software applications. Further, in the context of this disclosure, the computing elements shown in computing device 100 can correspond to a physical computing system (e.g., a system in a data center), can be a virtual computing embodiment executing within a computing cloud, or can correspond to a portion of a physical computing system (e.g., a neural processing chip).

In some embodiments, I/O devices 108 include devices capable of providing input, such as a keyboard, a mouse, a touch-sensitive screen, and so forth, as well as devices capable of providing output, such as a display device. In some embodiments, I/O devices 108 includes devices capable of both receiving input and providing output, such as a touchscreen, a universal serial bus (USB) port, and so forth. I/O devices 108 can be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 includes any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and can include fixed or removable disk drives, flash memory devices, and CD-ROM, DVD-ROM, Blu-Ray, HD-DVD, or other magnetic, optical, or solid-state storage devices. In some embodiments, positivity analysis application 120, explainability application 122, and/or model trainer 124 are stored in storage 114 and loaded into memory 116 when executed.

Memory 116 includes a random-access memory (RAM) module, a flash memory unit, or any other type of memory unit or combination thereof. Processing unit(s) 102, I/O device interface 104, and network interface 106 are configured to read data from and write data to memory 116. Memory 116 includes various software programs that can be executed by processor(s) 102 and application data associated with said software programs, including dataset 118, positivity analysis application 120, explainability application 122, and model trainer 124.

Dataset 118 includes observational data associated with a group of entities, such as, a group of people, objects, businesses, cities, countries, and/or the like. The observational data indicates attribute values for attributes, characteristics, and/or other variables associated with the group of entities. The specific attribute values included in the observational data can vary depending on the type of entity and the scenario being observed.

Additionally, dataset 118 includes data indicating whether each entity received a given treatment. As referred to herein, a “treatment” refers to an action that is applied to, or withheld from, entities included in the group of entities. For example, dataset 118 could include data that indicates a treatment value for each entity. A treatment value of 0 could indicate that the entity did not receive the treatment and a treatment value of 1 could indicate that the entity received the treatment. If dataset 118 is associated with multiple treatments (Le., multiple different actions can be applied to entities included in the group of entities), dataset 118 includes data that indicates which treatment(s) each entity received, if any. For example, dataset 118 could include a treatment vector for each entity. Each element in the vector corresponds to a different treatment, and the element value (e.g., 0 or 1) indicates whether the entity received the corresponding treatment.

In some embodiments, dataset 118 is stored in storage 114 and retrieved during execution of positivity analysis application 120, explainability application 112, and/or model trainer 124. In some embodiments, dataset 118 is received from an external data source, for example, via network 110.

As discussed in further detail below, positivity analysis application 120 and explainability application 122 analyze a dataset 118 to identify positivity violations that are included in dataset 118, if any. For a given treatment, dataset 118 includes data associated with one or more entities that received the given treatment (treatment group) and data associated with one or more entities that did not receive the given treatment (control group). Dataset 118 violates positivity (i.e., has a positivity violation) if, for a given combination of attribute values, only one group (e.g., treatment or control) includes an entity that has the given combination of attribute values. The positivity violation corresponds to the data associated with the entities that have the given combination of attribute values.

In order to identify positivity violations included in a dataset, a positivity analysis application 120 first analyzes dataset 118 to determine whether dataset 118 includes any positivity violations. If positivity analysis application 120 determines that dataset 118 includes one or more positivity violations, an explainability application 122 determines which combination(s) of attribute values are missing from one of the treatment group or control group. Additionally, in some embodiments, explainability application 122 generates a visual representation of the one or more positivity violations and/or one or more combinations of attribute values, such as human-readable text indicating the one or more combination of attribute values, charts or other graphics that illustrate the portion of dataset 118 that includes a positivity violation, and/or the like. Explainability application 122 displays the visual representation to a user, for example, via one of the I/O devices 108.

Model trainer 124 receives a dataset 118 and performs one or more model training operations based on dataset 118 to generate one or more trained machine learning models. In some embodiments, model trainer 124 trains a propensity model that is configured to receive a set of attribute values associated with an entity and generate a propensity score that indicates a likelihood that the entity received a treatment. As explained in further detail below, positivity analysis application 120 uses the trained machine learning model(s) when detecting positivity violations included in dataset 118. Although FIG. 1 illustrates a single dataset 118, in various embodiments, model trainer 124 trains one or more machine learning models using a first dataset 118 and positivity analysis application 120 and explainability application 122 analyze a second dataset 118. The first dataset 118 and the second dataset 118 can include different data points, i.e., have attribute values and/or correspond to different groups of entities.

Although FIG. 1 illustrates positivity analysis application 120, explainability application 122, and model trainer 124 executing on a single computing device 100, in other embodiments, functionality of the positivity analysis application 120, explainability application 122, and/or model trainer 124 can be distributed across any number of pieces of software that execute in any technically feasible manner and on any number of computing devices. For example, in some embodiments, positivity analysis application 120, explainability application 122, and model trainer 124 can reside on different computing devices and/or can operate at different points in time from one another. As another example, in some embodiments, a single application include functionality for both identifying areas of positivity violations and generating positivity violation explanations for the identified areas.

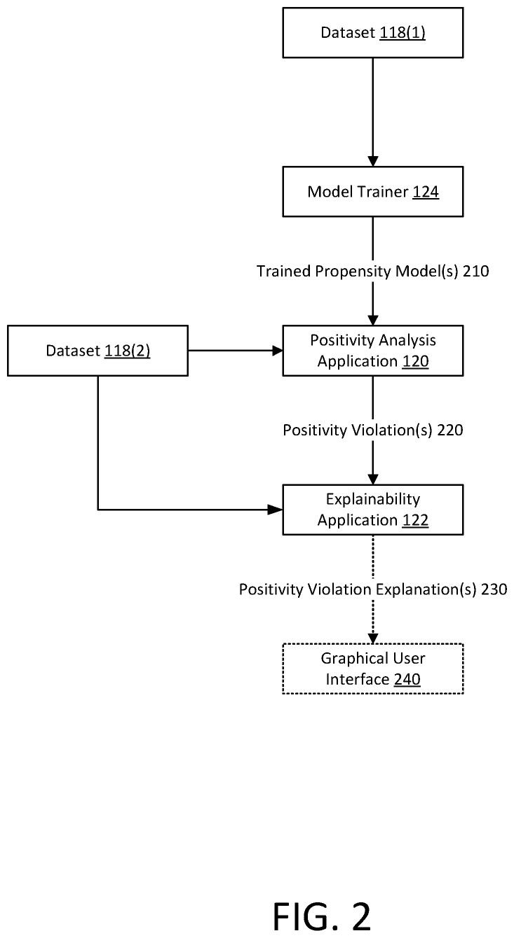

FIG. 2 is a conceptual diagram illustrating how positivity violations are detected and analyzed using the positivity analysis application 120 and explainability application 122 of FIG. 1, according to various embodiments. As shown in FIG. 2, a model trainer 124 receives a dataset 118(1). Dataset 118(1) includes observational data corresponding to a group of entities. Each data point included in dataset 118(1) corresponds to a different entity included in the group of entities and includes different attribute values for the corresponding entity. In some embodiments, each data point further includes one or more treatment values, where each treatment value indicates whether the corresponding entity received a corresponding treatment. In some embodiments, dataset 118(1) includes a separate set of data points that indicate whether each entity received a given treatment. For example, dataset 118(1) could include a data point for each entity, where each data point includes one or more treatment values for the corresponding entity. As another example, dataset 118(1) could include a data point for each treatment, where each data point includes treatment values for entities included in the group of entities.

Model trainer 124 trains one or more machine learning models based on the dataset 118(1) to generate one or more trained propensity models 210. Each trained propensity model 210 is configured to receive a set of attribute values associated with an entity and generate a propensity score that indicates a likelihood that the entity received a given treatment. In some embodiments, dataset 118(1) is associated with multiple treatments. Model trainer 124 trains, for each treatment, one or more corresponding propensity models 210 that predict whether an entity received the treatment. In various embodiments, model trainer 124 can train a propensity model 210 using any technically-feasible machine learning model algorithms or techniques. Additionally, a trained propensity model 210 can be any suitable machine learning model, for example and without limitation, a regression model, artificial neural network, support vector machine, decision tree, naïve Bayes classifier, and/or the like. Model trainer 124 provides the one or more trained propensity models 210 to positivity analysis application 120.

As shown in FIG. 2, positivity analysis application 120 receives one or more trained propensity models 210 from model trainer 124. Additionally, positivity analysis application 120 receives a dataset 118(2). Dataset 118(2) can be a different and/or modified dataset with respect to the dataset 118(1) used by model trainer 124 to generate the one or more trained propensity models 210. Generally, the dataset used by model trainer 124 and the positivity analysis application 120 (e.g., dataset 118(1) and dataset 118(2)) correspond to the same type of entity and are associated with the same attributes. However, the data points included in each dataset, such as the entities included in the datasets and/or the attribute values associated with different entities, could differ between the two datasets. As an example, dataset 118(1) could correspond to a first group of entities and dataset 118(2) could correspond to a second group of entities.

Positivity analysis application 120 analyzes dataset 118(2) to determine whether dataset 118(2) includes any positivity violations. As shown in FIG. 2, positivity analysis application 120 analyzes dataset 118(2) to identify one or more positivity violations 220 included in dataset 118(2). In some embodiments, positivity analysis application 120 uses the one or more trained propensity models 210 to generate propensity scores based on dataset 118(2). For a given treatment, positivity analysis application 220 uses the corresponding propensity model 210 to generate a plurality of propensity scores, where each propensity score indicates a likelihood that an entity associated with dataset 118(2) received the given treatment. That is, positivity analysis application 120 uses the trained propensity model 210 to predict whether each entity is included in a treatment group or a control group with respect to the given treatment. Positivity analysis application 120 determines, based on the plurality of propensity scores, whether dataset 118(2) includes any positivity violations 220 associated with the given treatment. As explained in further detail below, in some embodiments, positivity analysis application 120 divides the plurality of propensity scores into a first set of propensity scores associated with a treatment group and a second set of propensity scores associated with a control group, and compares the first set of propensity scores with the second set of propensity scores to determine whether any propensity scores are associated with a positivity violation 220.

Positivity analysis application 120 transmits data indicating the identified positivity violations 220 to explainability application 122. In some embodiments, positivity analysis application 120 identifies one or more portions of dataset 118(2) that are associated with a positivity violation. The data indicating the positivity violations 220 includes data indicating the one or more portions of dataset 118(2) that are associated with a positivity violation. For example, in some embodiments, positivity analysis application 120 generates, for each data point included in dataset 118(2), a label that indicates whether the data point corresponds to an area with a positivity violation based on the identified areas. Positivity analysis application 120 transmits dataset 118(2), including the generated labels, to explainability application 122. As another example, in some embodiments, positivity analysis application 120 uses one or more trained machine learning models, such as trained propensity models 210, to generate a plurality of propensity scores based on dataset 118(2), where each propensity score corresponds to a different entity. Positivity analysis application 120 determines, based on the plurality of propensity scores, one or more propensity scores that are associated with a positivity violation. Positivity analysis application 120 transmits the one or more propensity scores to explainability application 122.

In some embodiments, if positivity analysis application 120 determines that dataset 118(2) does not include any positivity violations, then positivity analysis application 120 does not transmit any data to explainability application 122. In some embodiments, if positivity analysis application 120 determines that dataset 118(2) does not include any positivity violations, positivity analysis application 120 displays a notification to a user indicating that no positivity violations were detected or causes another application to display the notification. For example, positivity analysis application 120 could transmit data to explainability application 122 that no positivity violations were detected. In response to receiving data indicating that no positivity violations were detected, explainability application 122 generates and displays an indication to a user, for example, via a graphical user interface of explainability application 122.

As shown in FIG. 2, explainability application 122 receives data indicating the one or more positivity violations 220 from positivity analysis application 120. Additionally, in some embodiments, explainability application 122 receives the dataset 118(2) from positivity analysis application 120. In some embodiments, explainability application 122 receives the dataset 118(2) separate from the one or more positivity violations 220. For example, explainability application 122 could retrieve dataset 118(2) from storage 114 in response to receiving the one or more positivity violations 220. Explainability application 122 analyzes dataset 118(2) based on the one or more positivity violations 220 to generate one or more positivity violation explanations 230. Each positivity violation explanation 230 includes a combination of one or more attribute values that are associated with a positivity violation. That is, each positivity violation explanation 230 indicates a combination of attribute values included in dataset 118(2), where entities having the combination of attribute values are included in only one of the treatment group or the control group for a given treatment.

Optionally, explainability application 122 displays the positivity violation explanations 230 in a graphical user interface 240. For example, in some embodiments, explainability application 122 generates explanation text based on the one or more positivity violation explanations 230. The explanation text indicates, for each positivity violation explanation 230, the combination of attribute values associated with the positivity violation explanation 230. Explainability application 122 displays the explanation text to a user using graphical user interface 240.

In some embodiments, positivity analysis application 120 and/or explainability application 122 modify dataset 118 based on the one or more positivity violations 220 to generate a modified dataset 118 that does not include the positivity violations 220. For example, after identifying a given positivity violation 220, positivity analysis application 120 could remove one or more data points associated with the positivity violation 220 from dataset 118. As another example, after generating a positivity violation explanation 230, explainability application 122 could remove one or more data points having the combination of attribute values indicated by the positivity violation explanation 230 from dataset 118. Because the modified dataset 118 does not include the identified positivity violations 220, causal inference can be performed successfully, or more accurately, using modified dataset 118 compared to the original dataset 118.

### Positivity Violation Detection using Propensity Scores

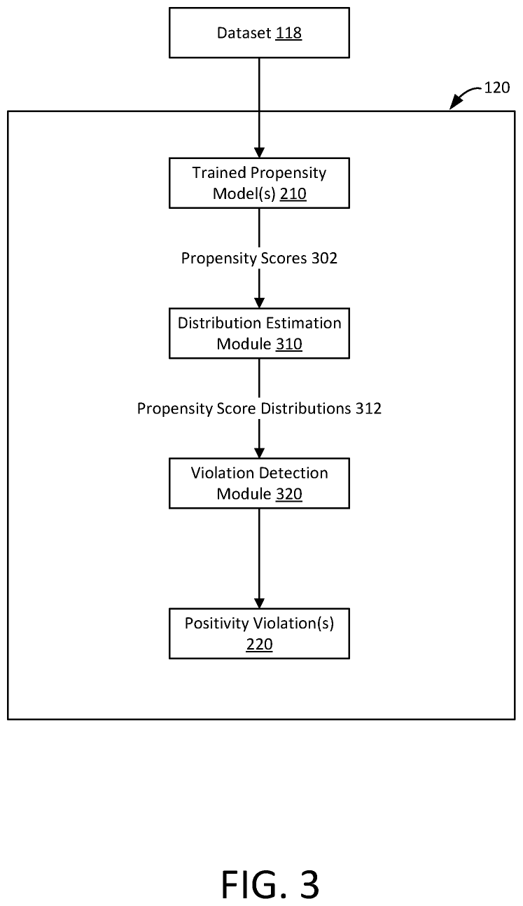

FIG. 3 is a more detailed illustration of the positivity analysis application 120 of FIG. 1, according to various embodiments. As shown in FIG. 3, positivity analysis application 120 includes one or more trained propensity models 210, a distribution estimation module 310, and a violation detection module 320.

Positivity analysis application 120 receives a dataset 118. Positivity analysis application 120 uses a trained propensity model 210 to generate a plurality of propensity scores 302 based on the dataset 118. The trained propensity model 210 predicts whether an entity belongs to a treatment group or a control group with respect to a treatment associated with the trained propensity model 210. In some embodiments, for each entity associated with dataset 118, positivity analysis application 120 provides one or more attribute values associated with the entity as input to a trained propensity model 210 and receives, from the trained propensity model 210, a propensity score 302 that indicates a likelihood that the entity received the associated treatment.

In some cases, dataset 118 is associated with multiple treatments. In some embodiments, positivity analysis application 120 generates, for each treatment associated with dataset 118, a plurality of propensity scores 302 using a trained propensity model 210 associated with the treatment. In some embodiments, positivity analysis application 120 determines one or more target treatments. Determining the one or more target treatments could be based on, for example, user input selecting one or more particular treatments, configuration information associated with dataset 118, receiving treatment values corresponding to only the one or more target treatments, and/or the like. Positivity analysis application 120 generates, for each target treatment, a plurality of propensity scores 302 using a trained propensity model 210 associated with the target treatment. The number of target treatments can be fewer than the number of treatments associated with dataset 118. Accordingly, in such embodiments, positivity analysis application 120 identifies positivity violations 220 associated with the target treatment(s) but does not identify positivity violations 220 associated with treatments that are not included in the target treatment(s).

Positivity analysis application 120 analyzes the propensity scores 302 to identify propensity scores that are associated with a positivity violation 220. As shown in FIG. 3, a distribution estimation module 310 generates multiple propensity score distributions 312 based on the propensity scores 302. In some embodiments, for a given treatment, distribution estimation module 310 generates a first propensity score distribution 312 based on the propensity scores 302 associated with entities included in a treatment group and a second propensity score distribution 312 based on the propensity scores 302 associated with entities included in a control group. In some embodiments, for a given treatment, distribution estimation module 301 generates a propensity score distribution based on the propensity scores 302 associated with the given treatment. The distribution includes both propensity scores associated with entities included in the treatment group and entities included in the control group.

In some embodiments, to generate a propensity score distribution 312 based on a plurality of propensity scores 302, distribution estimation module 310 generates a plurality of histogram bins based on the possible range of propensity scores (e.g., from 0to 1). As an example, distribution estimation module 310 could generate 100 histogram bins of equal size, such that each histogram bin corresponds to one percent of the propensity area (e.g., a first bin corresponds to propensity scores from 0 to 0.01, a second bin corresponds to propensity scores from 0.01 to 0.02, and so forth). Distribution estimation module 310 sorts the plurality of propensity scores 302 into the different histogram bins. In various embodiments, any suitable number of histogram bins and/or histogram bins of any suitable size can be used.

In some embodiments, distribution estimation module 310 generates a single histogram for each treatment, or target treatment, associated with dataset 118. In such embodiments, a histogram bin could include both propensity scores associated with entities included in the control group as well as propensity scores associated with entities included in the treatment group. In some embodiments, distribution estimation module 310 divides the plurality of propensity scores for each treatment, or target treatment, into a first subset associated with entities included in the treatment group and a second subset associated with entities included in the control group. Distribution estimation module 310 generates a first histogram based on the first subset and a second histogram based on the second subset. Accordingly, in such embodiments, histogram bins included in the first histogram indicate a number of propensity scores with the associated value that are associated with the treatment group and histogram bins included in the second histogram indicate a number of propensity scores with the associated value that are associated with the control group.

Violation detection module 320 analyzes the propensity score distributions 312 to identify one or more potential positivity violations. In some embodiments, a first propensity score distribution 312 corresponds to propensity scores for a treatment group and a second propensity score distribution 312 corresponds to propensity scores for a control group. Violation detection module 320 compares the first propensity score distribution 312 with the second propensity score distribution 312 to identify areas of the distributions where one distribution is 0 (i.e., does not include any propensity scores) and one distribution is not (i.e., includes at least one propensity score). If no such areas exist, then violation detection module 320 determines that dataset 118 does not include any positivity violations.

As an example, violation detection module 320 could compare each histogram bin in a first histogram with a corresponding histogram bin in a second histogram. For a given histogram bin number, if one of the histogram bins or the corresponding histogram bin has a zero count and the other has a non-zero count, then the histogram bin number (i.e., the range of propensity score values corresponding to the histogram bin) corresponds to a potential positivity violation.

In some embodiments, a propensity score distribution 312 includes both propensity scores associated with the treatment group and propensity scores associated with the control group. Violation detection module 320 identifies areas of the propensity score distribution 312 where the distribution includes only propensity scores associated with one of the treatment group or control group. For example, violation detection module 320 could determine, for each histogram bin of a histogram, the number of propensity scores associated with the treatment group and the number of propensity scores associated with the control group. If one number is zero but the other is not, then violation detection module 320 determines that the histogram bin is associated with a potential positivity violation.

Violation detection module 320 identifies one or more positivity violations 220 based on the potential positivity violations. In some embodiments, the one or more positivity violations 220 correspond to the one or more potential positivity violations. In some embodiments, violation detection module 320 performs one or more statistical operations on the one or more potential positivity violations to identify the positivity violation(s) 220. For example, in some embodiments, violation detection module 320 performs one or more statistical operations to determine, for each potential positivity violation, whether the potential positivity violation is significant. In some embodiments, violation detection module 320 computes a p-value associated with the potential positivity violation. If the p-value is less than a threshold value (e.g., 1%), then the potential positivity violation is significant. If a potential positivity violation is significant, then violation detection module 320 identifies the potential positivity violation as a positivity violation 220. If the potential positivity violation is not significant, then violation detection module 320 does not identify the potential positivity violation as a positivity violation 220. If no potential positivity violations are significant, then violation detection module 320 determines that no positivity violations are present in dataset 118. Any suitable statistical significance test can be used to determine a significance of a potential positivity violation, including and without limitation, two-sample proportion hypothesis test, Fisher's exact text, other contingency table statistical tests, and/or the like.

In some embodiments, violation detection module 320 corrects the generated p-values to reduce errors introduced when conducting multiple comparisons. Violation detection module 320 can use any suitable approach or techniques for correcting p-values, including and without limitation, any type of false discovery rate (FDR) procedure. Violation detection module 320 determines whether any of the potential positivity violations are significant after correcting the p-values associated with the potential positivity violations. If a potential positivity violation is significant, then violation detection module 320 identifies the potential positivity violation as a positivity violation 220. If the potential positivity violation is not significant, then violation detection module 320 does not identify the potential positivity violation as a positivity violation 220.

In some embodiments, if violation detection module 320 determines that dataset 118 includes one or more positivity violations 220, then violation detection module 320 generates data indicating the portions of dataset 118 associated with the one or more positivity violations 220. For example, in some embodiments, violation detection module 320 generates data indicating one or more propensity scores associated with the one or more positivity violations. Additionally, violation detection module 320 could modify dataset 118 to include the propensity score associated with each entity.

As another example, in some embodiments, violation detection module 320 generates labels for the data points included in dataset 118 based on the one or more positivity violations 220. For each data point, the corresponding label indicates whether the data point is associated with a positivity violation 220. For example, if violation detection module 320 determined that a histogram bin is associated with a positivity violation 220, then violation detection module 320 labels each data point included in the histogram bin with a label indicating that the data point is associated with a positivity violation (e.g., a “violation” label). If a histogram bin is not associated with a positivity violation, then violation detection module 320 labels each data point included in the histogram bin with a label indicating that the data point is not associated with a positivity violation (e.g., a “non-violation” label). Additionally, in some embodiments, the corresponding label is associated with the treatment associated with the positivity violation 220 (e.g., if dataset 118 is associated with multiple treatments or target treatments) and/or indicates the treatment associated with the positivity violation.

Violation detection module 320 transmits the data indicating the one or more positivity violations to explainability application 122. For example, violation detection module 320 could transmit the labels generated for dataset 118. Additionally, violation detection module 320 could transmit the dataset 118 that was analyzed. In some embodiments, violation detection module 320 modifies dataset 118 to include the labels and transmits the modified dataset 118, including the labels, to explainability application 122.

### Explaining Detected Positivity Violations

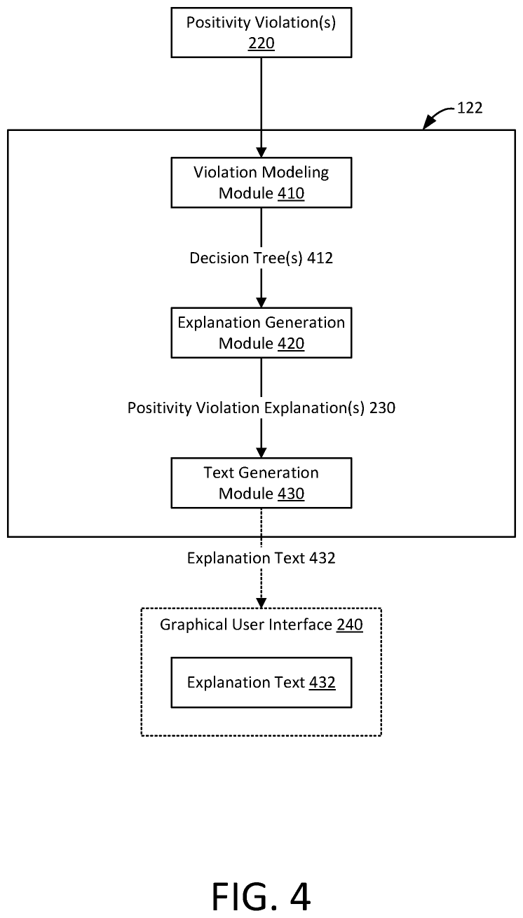

FIG. 4 is a more detailed illustration of the explainability application 122 of FIG. 1, according to various embodiments. As shown in FIG. 4, explainability application 122 includes a violation modeling module 410, an explanation generation module 420, and a text generation module 430.

Explainability application 122 receives one or more positivity violations 220. In some embodiments, explainability application 122 receives the one or more positivity violations 220 from positivity analysis application 120. In some embodiments, positivity analysis application 120 stores the one or more positivity violations 220, for example in storage 114, and explainability application 122 retrieves the one or more stored positivity violations 220. Additionally, in some embodiments, explainability application 122 receives a dataset 118 that includes the one or more positivity violations 220.

In some embodiments, the one or more positivity violations 220 include data indicating one or more portions of a dataset 118 that are associated with a positivity violation. For example, in some embodiments, dataset 118 includes, in addition to the attribute value(s) and/or treatment value(s) associated with each entity, one or more propensity scores associated with each entity. The one or more positivity violations 220 could include data indicating one or more propensity scores that are associated with a positivity violation. As another example, in some embodiments, the one or more positivity violations 220 include one or more labels corresponding to each entity associated with dataset 118. Each label indicates whether the data point corresponding to the entity is associated with a positivity violation. In some embodiments, the one or more labels are included in dataset 118, in addition to attribute value(s) and/or treatment value(s) associated with the entity.

Explainability application 122 analyzes dataset 118 based on the one or more positivity violations 220 to generate one or more positivity violation explanation(s) 230. As shown in FIG. 4, a violation modeling module 410 receives the one or more positivity violations 220 and performs one or more training operations on dataset 118 based on the one or more positivity violations 220 to generate one or more trained decision trees 412.

Each node of a trained decision tree corresponds to a different attribute and is associated with a subset of dataset 118 that includes one or more attribute values for the corresponding attribute. For example, in some embodiments, each branch of the decision tree is associated with a comparison operation for splitting the dataset 118 among multiple child nodes based on an attribute that corresponds to the child nodes. As an example, at a given branch, the decision tree could split into a left node and a right node. Both the left node and the right node correspond to the same attribute, but the left node is associated with attribute values that are less than or equal to a threshold value and the right node is associated with attribute values that are greater than the threshold value. Accordingly, the left node includes data points of dataset 118 where the attribute value of the corresponding attribute is less than or equal to the threshold value, and the left node includes data points of dataset 118 where the attribute value of the corresponding attribute is greater than the threshold value.

In some embodiments, violation modeling module 410 trains a decision tree 412 to differentiate between areas of the dataset 118 that violate positivity and areas of the dataset 118 that do not violate positivity. During training, violation modeling module 410 uses the data indicating the one or more portions of dataset 118 that are associated with a positivity violation to identify the areas of dataset 118 that violate positivity and the areas of dataset 118 that do not. For example, violation modeling module 410 could use labels associated with dataset 118 (e.g., “positive” and “non-positive” labels, “violation” and “non-violation” labels, and/or the like) to train a decision tree 412. In various embodiments, violation modeling module 410 can use any suitable decision tree training algorithm(s) to generate a trained decision tree 412.

In some embodiments, for a given treatment, violation modeling module 410 divides the dataset 118 into a first subset of data that is associated with entities included in the treatment group and a second subset of data that is associated with entities included in the control group. Violation modeling module 410 performs one or more training operations on the first subset of data based on the one or more positivity violations 220 to generate a first trained decision tree 412 that is associated with the treatment group. Violation modeling module 410 performs one or more training operations on the second subset of data based on the one or more positivity violations 220 to generate a second trained decision tree 412 that is associated with the control group.

In some cases, dataset 118 is associated with multiple treatments. In some embodiments, violation modeling module 410 generates a pair of decision trees 412 for each treatment associated with dataset 118. In some embodiments, violation modeling module 410 determines one or more target treatments. Determining the one or more target treatments could be based on, for example, user input selecting one or more particular treatments, configuration information associated with dataset 118, receiving treatment values corresponding to only the one or more target treatments, receiving an indication of the one or more target treatments from positivity analysis application 120, and/or the like.

In some embodiments, after generating a trained decision tree 412, violation modeling module 410 prunes the decision tree 412 to remove one or more nodes from the decision tree 412. For example, in some embodiments, explainability application 122 determines, for each node of the decision tree, whether the data points included in the node satisfy a threshold condition. If the data points included in a given node satisfy the threshold condition, then explainability application 122 makes the given node a leaf node. As a result, any nodes that are child nodes of the given node are removed, or pruned, from the decision tree.

In some embodiments, the threshold condition is based on the number of data points included in a node that are associated with a positivity violation. For example, a threshold condition could be the percentage of a node that is associated with a positivity violation being greater than a threshold percentage (e.g., more than 90% of the data points included in a node are associated with positivity violations). Pruning based on this threshold condition removes over-fitted rules from the trained decision tree. As another example, a threshold condition could be the percentage of all data points associated with positivity violations that are contained in a node being less than a threshold percentage (e.g., fewer than 1% of the entire set of non-positive data points are included in the node). Pruning based on this threshold condition discards areas of non-positivity (Le., areas of dataset 118 associated with positivity violations) that are too small to be meaningful. Any number and/or type of suitable threshold conditions can be used to prune a decision tree 412. For example, both of the threshold conditions discussed above could be used to prune a given decision tree 412.

As shown in FIG. 4, an explanation generation module 420 receives the one or more trained decision trees 412 and generates one or more positivity violation explanations 230. In some embodiments, the one or more trained decision trees 412 are pruned decision trees. In some embodiments, violation modeling module 410 does not prune the trained decision trees 412. Instead, explanation generation module 420 receives the one or more trained decision trees 412 and performs one or more pruning operations on the trained decision trees 412 to generate pruned decision trees.

In some embodiments, explanation generation module 420 generates, for each trained decision tree 412, a positivity violation explanation 230 associated with the trained decision tree 412. Each positivity violation explanation 230 indicates a combination of attribute values associated with a positivity violation. For example, if a given trained decision tree 412 is associated with a treatment group of a given treatment, then the positivity violation explanation 230 indicates a combination of attribute values that are associated with the treatment group but are not associated with the control group.

In some embodiments, explanation generation module 420 generates a positivity violation explanation 230 based on the leaf nodes of a trained decision tree 412. In some embodiments, explanation generation module 420 generates a different positivity violation explanation 230 for each leaf node included in the trained decision tree 412. For a given leaf node included in the trained decision tree 412, a path from the root node to the given leaf node indicates the combination of attribute values to be included in the positivity violation explanation 230. For example, assume a leaf node is associated with attribute values less than 45 for the attribute “days since last login,” the parent of the leaf node is associated with attribute values of 1000 or more for the attribute “account age,” and the grandparent of the leaf node is the root node. The combination of attribute values leading to the leaf node would be “account age” greater than or equal to 1000 and “days since last login” less than 45. Accordingly, the positivity violation explanation 230 includes the set of attribute values: {account age>=1000; days since last login <45}. In various embodiments, explanation generation module 420 can use any suitable data structure and/or data format to represent the one or more positivity violation explanations 230. In some embodiments, the positivity violation explanation 230 includes a representation of the trained decision tree 412.

As shown in FIG. 4, explanation generation module 420 transmits the one or more positivity violation explanations 230 to a text generation module 430. Text generation module 430 generates explanation text 432 based on the one or more positivity violation explanations 230. In some embodiments, text generation module 430 translates each attribute value included in a given positivity violation explanation 230 into human-readable text. For example, text generation module 430 could translate attribute values into text having the format “[attribute name] is [less than/greater than/less than or equal to/greater than or equal to] [amount]” based on the attribute, comparison operation, and threshold value associated with the attribute value indicated by the positivity violation explanation 230.

Optionally, in some embodiments, explainability application 122 displays the positivity violation explanations 230 to a user of computing device 100. For example, as shown in FIG. 4, explainability application 122 displays the explanation text 432 in a graphical user interface 240. In some embodiments, explainability application 122 displays other types of visual representations of the positivity violation explanations 230, in addition to or instead of explanation text 432. For example, explainability application 122 could display a visual representation of the one or more trained decision trees 412 and indicates the attribute values associated with the nodes of each decision tree 412.

In some embodiments, explainability application 122 generates explanation text 432 based on a trained decision tree 412 without specifically generating a positivity violation explanation 230. For example, explainability application 122 could directly generate explanation text 412 while traversing from the root node of a decision tree 412 to a leaf node, rather than generating a positivity violation explanation 230 and translating the positivity violation explanation 230 to human-readable text.

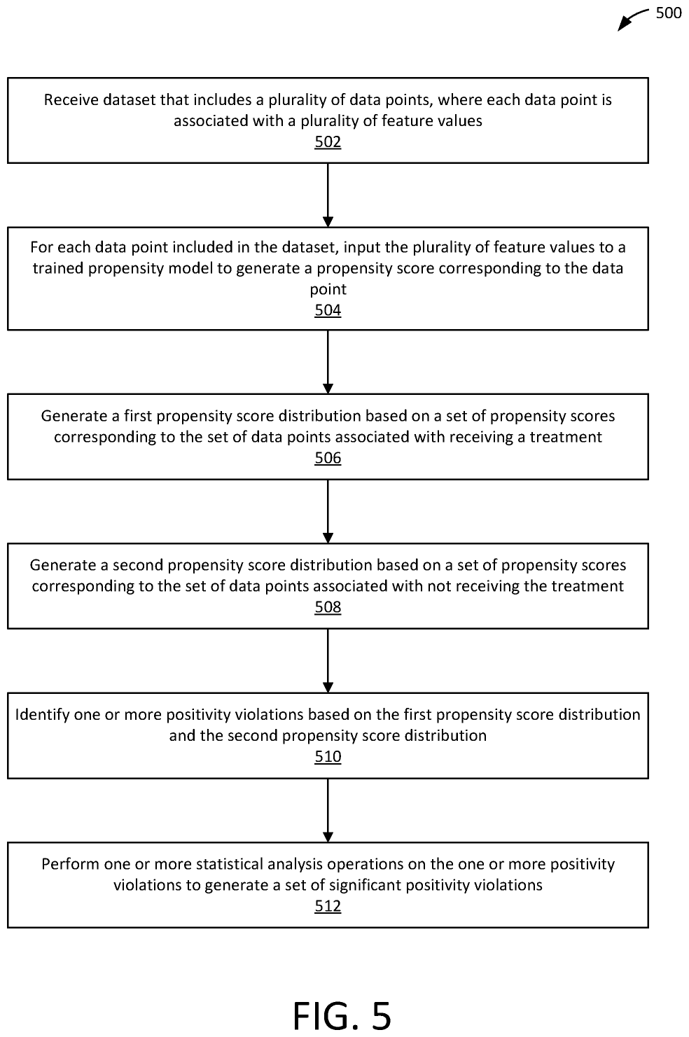

FIG. 5 is a flow chart of method steps for detecting positivity violations using a trained machine learning model, according to various embodiments. Although the method steps are described in conjunction with the systems of FIGS. 1-4, persons of ordinary skill in the art will understand that any system configured to perform the method steps, in any order, is within the scope of the present disclosure.

As shown in FIG. 5, a method 500 begins at step 502, where a positivity analysis application 120 receives a dataset 118 that includes a plurality of data points, where each data point is associated with a plurality of feature values. Each data point corresponds to a different entity associated with dataset 118, and each feature value corresponds to, for example, an attribute, characteristic, or other variable associated with the entity.

At step 504, for each data point included in the dataset 118, positivity analysis application 120 inputs the plurality of feature values associated with the data point to a trained propensity model 210 to generate a propensity score 302 corresponding to the data point. In some embodiments, the trained propensity model 210 is associated with a given treatment and the propensity score 302 indicates a likelihood that the entity corresponding to the data point received the given treatment.

At step 506, positivity analysis application 120 generates a first propensity score distribution 312 based on a set of propensity scores 302 corresponding to the set of data points associated with receiving a treatment. The first propensity score distribution 312 indicates the distribution of propensity scores 302 for entities included in a treatment group.

At step 508, positivity analysis application 120 generates a second propensity score distribution 312 based on a set of propensity scores 302 corresponding to the set of data points associated with not receiving the treatment. The second propensity score distribution 312 indicates the distribution of propensity scores 302 for entities in a control group.

Generating the first propensity score distribution and the second propensity score distribution is performed in a manner similar to that discussed above with respect to positivity analysis application 120 and distribution estimation module 310. In some embodiments, positivity analysis application 120 divides the plurality of propensity scores 302 generated at step 504 into a first subset associated with a treatment group and a second subset associated with a control group. Positivity analysis application 120 generates the first propensity score distribution based on the first subset of propensity scores and the second propensity score distribution based on the second subset of propensity scores.

In some embodiments, positivity analysis application 120 generates a plurality of histogram bins. Positivity analysis application 120 sorts each propensity score 302 into one of the histogram bins included in the plurality of histogram bins based on the range of propensity score values associated with each histogram bin.

At step 510, positivity analysis application 120 identifies one or more potential positivity violations based on the first propensity score distribution and the second propensity score distribution. Identifying the one or more potential positivity violations is performed in a manner similar to that discussed above with respect to positivity analysis application 120 and violation detection module 320.

In some embodiments, positivity analysis application 120 compares the first propensity score distribution and the second propensity score distribution to identify areas of the propensity score distributions where one distribution is zero and the other is non-zero. Each area is associated with a potential positivity violation.

In some embodiments, the first propensity score distribution and the second propensity score distribution include a corresponding plurality of histogram bins. Positivity analysis application 120 compares each histogram bin included in the first propensity score distribution with the corresponding histogram bin in the second propensity score distribution to identify bins where one bin count is zero and the other is non-zero. Each identified histogram bin is associated with a potential positivity violation.

In some embodiments, the first propensity score distribution and the second propensity score distribution are included in the same histogram. For each histogram bin of the histogram, positivity analysis application 120 determines the number of propensity scores in the bin that are associated with the treatment group and the number of propensity scores in the bin that are associated with the control group to identify bins where one number of propensity scores is zero and the other is non-zero. Each identified bin is associated with a potential positivity violation.

At step 512, positivity analysis application 120 performs one or more statistical analysis operations on the one or more potential positivity violations to generate a set of significant positivity violations. The set of significant positivity violations can include any number of positivity violations, including zero. Generating the set of significant positivity violations is performed in a manner similar to that discussed above with respect to positivity analysis application 120 and violation detection module 320.

In some embodiments, positivity analysis application 120 determines a p-value associated each potential positivity violation. Positivity analysis application 120 compares the p-value with a threshold value to determine whether the potential positivity violation is significant. If the p-value is less than the threshold amount, then positivity analysis application determines that the potential positivity violation is significant and includes the potential positivity violation in the set of significant positivity violations. Additionally, in some embodiments, positivity analysis application 120 performs one or more false discovery rate operations to correct the p-values generated for the one or more potential positivity violations. Positivity analysis application 120 determines whether each potential positivity violation is significant based on the corrected p-value associated with the potential positivity violation.

In some embodiments, generating the set of significant positivity violations includes generating data indicating the portions of the dataset 118 that are associated with the set of significant positivity violations. In some embodiments, positivity analysis application 120 generates a label for each data point included in dataset 118 indicating whether the data point is associated with the set of significant positivity violations. For example, a data point that is associated with the set of significant positivity violations could be labeled “violation” or “non-positive,” while a data point that is not associated with the set of significant positivity violations could be labeled “non-violation” or “positive.” In some embodiments, if a data point is associated with a potential positivity violation but positivity analysis application 120 determines that the potential positivity violation is not significant, then the data point is not labeled as being associated with the set of significant positivity violations (e.g., is labeled as non-violation or positive).

In some embodiments, if dataset 118 is associated with multiple treatments, the steps 504-512 above are repeated for each treatment. For each treatment, a trained propensity model 210 associated with the treatment is used to generate a plurality of propensity scores associated with the treatment. A set of significant positivity violations is generated for each treatment. The significant positivity violations and/or the number of significant positivity violations can vary for different treatments.

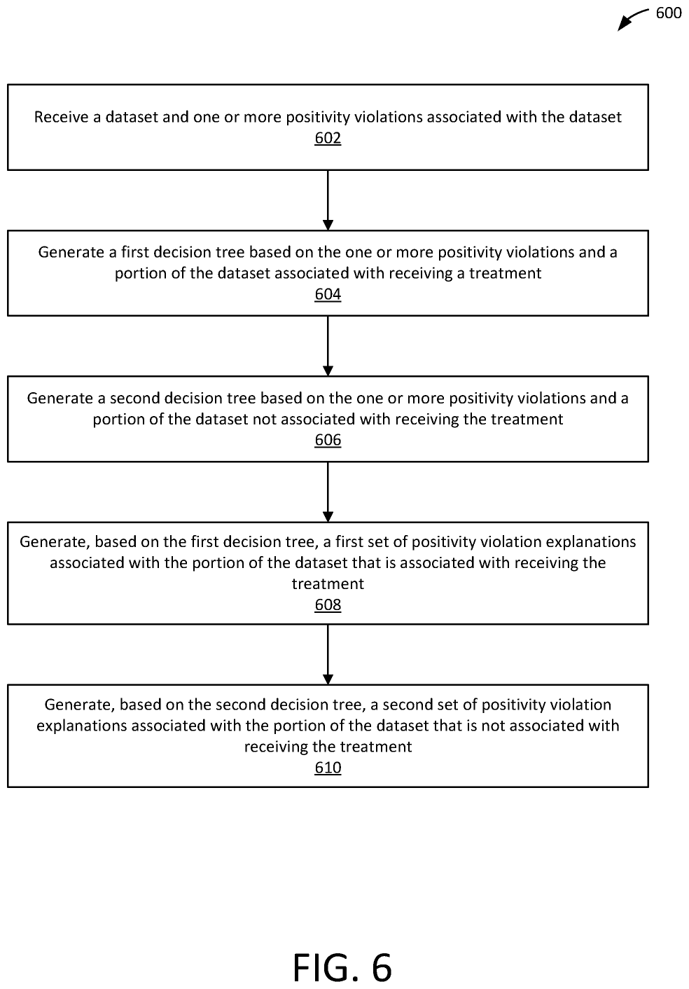

FIG. 6 is a flow chart of method steps for generating positivity violation explanations based on one or more potential positivity violations, according to various embodiments. Although the method steps are described in conjunction with the systems of FIGS. 1-4, persons of ordinary skill in the art will understand that any system configured to perform the method steps, in any order, is within the scope of the present disclosure.

As shown in FIG. 6, a method 600 begins at a step 602, where an explainability application 122 receives a dataset 118 and one or more positivity violations 220 associated with the dataset 118. The one or more positivity violations 220 include data indicating one or more portions of a dataset 118 that are associated with a positivity violation.

In some embodiments, explainability application 122 receives the one or more positivity violations 220 from a positivity analysis application 120. In some embodiments, the positivity analysis application 120 stores the one or more positivity violations 220, and explainability application 122 retrieves the one or more stored positivity violations 220.

At step 604, explainability application 122 generates a first decision tree 412 based on the one or more positivity violations 220 and a portion of the dataset 118 associated with receiving a treatment. Generating a decision tree based on one or more positivity violations is performed in a manner similar to that discussed above with respect to explainability application 122 and violation modeling module 410.

In some embodiments, explainability application 122 performs one or more training operations on the portion of dataset 118 based on the one or more positivity violations 220. For example, explainability application 122 could perform training operations based on whether each data point is labeled as a positivity violation or a non-violation. The first decision tree 412 is trained to determine whether a given attribute value or range of attribute values contributes to a positivity violation.

In some embodiments, explainability application 122 prunes the first decision tree 412 to generate a first pruned decision tree 412. The leaf nodes of the first pruned decision tree 412 include nodes of the first decision tree 412 that satisfy a pruning criteria.

In some embodiments, explainability application 122 compares the number of data points included in a given node that are associated with a positivity violation with the total number of data points included in the given node. If the percentage of data points that are associated with a positivity violation is greater than a threshold percentage, then the explainability application 122 makes the given node a leaf node and prunes any child nodes of the given node.

In some embodiments, explainability application 122 compares the number of data points included in a given node that are associated with a positivity violation with the total number of data points in dataset 118 that are associated with the one or more positivity violations. If the percentage of data points that are associated with the one or more positivity violations that are included in the given node is less than a threshold percentage, then explainability application 122 makes the given node a leaf node and prunes any child nodes of the given node.

At step 606, explainability application 122 generates a second decision tree 412 based on the one or more positivity violations 220 and a portion of the dataset 118 not associated with receiving a treatment. Generating the second decision tree is performed in a manner similar to generating the first decision tree at step 604 above.

In some embodiments, explainability application 122 performs one or more training operations on the portion of dataset 118 based on the one or more positivity violations 220. For example, explainability application 122 could perform training operations based on whether each data point is labeled as a positivity violation or a non-violation. The second decision tree 412 is trained to determine whether a given attribute value or range of attribute values contributes to a positivity violation.

In some embodiments, explainability application 122 prunes the second decision tree 412 to generate a second pruned decision tree 412. The leaf nodes of the second pruned decision tree 412 include nodes of the second decision tree 412 that satisfy a pruning criteria, such as the number of data points associated with positivity violations being above or below a threshold amount.

At step 608, explainability application 122 generates, based on the first decision tree 412, a first set of positivity violation explanations 230 associated with the portion of the dataset 118 that is associated with receiving the treatment. Each positivity violation explanation 230 indicates a different combination of attribute values that are associated with a positivity violation. Generating a positivity violation explanation 230 is performed in a manner similar to that discussed above with respect to explainability application 122 and explanation generation module 420.

In some embodiments, explainability application 122 generates a positivity violation explanation 230 for each leaf node included in the first decision tree 412. For a given leaf node explainability application 122 traverses the first decision tree 412 from the root node to the given leaf node. The attribute values associated with each branch of the first decision tree 412 leading to the given leaf node are included in the positivity violation explanation 230.

At step 610, explainability application 122 generates, based on the second decision tree 412, a second set of positivity violation explanations 230 associated with the portion of the dataset 118 that is not associated with receiving the treatment. Each positivity violation explanation 230 indicates a different combination of attribute values that are associated with a positivity violation. Generating a positivity violation explanation 230 is performed in a manner similar to that discussed above with respect to explainability application 122 and explanation generation module 420.

In some embodiments, explainability application 122 generates a positivity violation explanation 230 for each leaf node included in the second decision tree 412. For a given leaf node explainability application 122 traverses the second decision tree 412 from the root node to the given leaf node. The attribute values associated with each branch of the second decision tree 412 leading to the given leaf node are included in the positivity violation explanation 230.

In some embodiments, explainability application 122 displays the first set of positivity violation explanations 230 and/or second set of positivity violation explanations 230 in a graphical user interface. In some embodiments, displaying a set of positivity violation explanations includes generating an explanation text 432 and/or other visual representation based on the set of positivity violation explanations.

In some embodiments, explainability application 122 modifies the dataset 118 based on the first set of positivity violation explanations 230 and/or the second set of positivity violation explanations 230 to generate a dataset 118 that does not include the one or more positivity violations 220.

In sum, the disclosed techniques generate one or more positivity violations for a set of observational data. The set of observational data includes, for a group of entities, different attribute values associated with each entity. The group of entities includes a treatment group and a control group. The treatment group includes one or more entities that received a given treatment and the control group includes one or more entities that did not receive the given treatment. Each positivity violation indicates a different combination of attribute values where only one of the treatment group or the control group includes an entity associated with the combination of attribute values.

A trained machine learning model is applied to the set of observational data to generate a set of propensity scores. Each propensity score corresponds to a different entity included in the group of entities and is generated based on the attribute values associated with the entity. The propensity score indicates a predicted likelihood of the entity receiving the given treatment. A first distribution corresponding to the treatment group is generated based on the propensity scores associated with entities included in the treatment group. A second distribution corresponding to the control group is generated based on the propensity scores associated with entities included in the control group. One or more potential positivity violations are identified based on the first distribution and the second distribution. Each potential positivity violation indicates a propensity score, or a range of propensity scores, where the portion of the set of observational data might include a positivity violation.

A first decision tree corresponding to the treatment group is trained based on the one or more potential positivity violations and a subset of observational data that is associated with the treatment group. A second decision tree corresponding to the control group is trained based on the one or more potential positivity violations and a subset of observational data that is associated with the control group. Each leaf node of a trained decision tree corresponds to an attribute value, or range of values for a given attribute, where all data points associated with the attribute value or range of attribute values correspond to a suspected positivity violation. As a result, the combination of leaf nodes of a trained decision tree indicates a combination of attribute values where a positivity violation has occurred.

At least one technical advantage of the disclosed techniques relative to the prior art is that, with the disclosed techniques, positivity violations are detected in a high-dimensionality dataset using less time and fewer computing resources relative to prior approaches. More specifically, by using a trained machine learning model to generate multiple propensity scores from a given dataset and then analyzing those propensity scores to detect positivity violations, the number of dimensions analyzed is reduced from multiple dimensions, equal to the number of attributes included in the given dataset, to a single dimension, the actual propensity scores. As a result, identifying positivity violations using the disclosed techniques can be substantially faster and can be accomplished using substantially fewer processing resources relative to conventional techniques. These technical advantages provide one or more technological improvements over prior art approaches.

1. In some embodiments, a computer-implemented method for detecting positivity violations within a dataset comprises generating, using a trained machine learning model, a plurality of propensity scores based on observational data associated with a group of entities, wherein, for each entity included in the group of entities, the observational data includes a plurality of attribute values associated with the entity, and wherein the group of entities comprises a subset of first entities that received a treatment and a subset of second entities that did not receive the treatment; analyzing the plurality of propensity scores to identify one or more potential positivity violations; performing one or more training operations on the observational data based on the one or more potential positivity violations to generate a first trained decision tree associated with the one or more potential positivity violations; and determining, based on the trained first decision tree, a first positivity violation comprising a first combination of attribute values that is associated with at least one entity included in the subset of first entities and is not associated with any entity included in the subset of second entities.

2. The computer-implemented method of clause 1, wherein the trained machine learning model is trained to receive one or more attribute values associated with an entity and determine a likelihood that the entity received the treatment.

3. The computer-implemented method of clause 1 or clause 2, wherein analyzing the plurality of propensity scores comprises dividing the plurality of propensity scores into a first subset of propensity scores associated with the subset of first entities and a second subset of propensity scores associated with the subset of second entities.

4. The computer-implemented method of any of clauses 1-3, wherein analyzing the plurality of propensity scores comprises: generating a plurality of histogram bins based on the plurality of propensity scores; and identifying at least one histogram bin that includes one or more propensity scores associated with the subset of first entities and does not include one or more propensity scores associated with the subset of second entities.

5. The computer-implemented method of any of clauses 1-4, wherein analyzing the plurality of propensity scores comprises: generating a plurality of histogram bins based on the plurality of propensity scores; and identifying at least one histogram bin that includes one or more propensity scores associated with the subset of second entities and does not include one or more propensity scores associated with the subset of first entities.

6. The computer-implemented method of any of clauses 1-5, further comprising: performing one or more statistical analysis operations on the one or more potential positivity violations to determine a significance associated with each potential positivity violation included in the one or more potential positivity violations; and wherein performing one or more training operations on the observational data is further based on the significance determined for each potential positivity violation included in the one or more potential positivity violations.

7. The computer-implemented method of any of clauses 1-6, wherein each node included in the first decision tree corresponds to a different attribute included in the observational data and is associated with a subset of observational data that includes one or more attribute values for the corresponding attribute.

8. The computer-implemented method of any of clauses 1-7, wherein performing the one or more training operations comprises: determining, for a first node included in the first decision tree, that a number of data points that are associated with the first node and correspond to the one or more potential positivity violations satisfies a threshold level; and in response to determining that the number of data points satisfies the threshold level, selecting the first node as a leaf node of the first decision tree.

9. The computer-implemented method of any of clauses 1-8, further comprising causing a visual representation of the first positivity violation to be displayed to a user via a graphical user interface.

10. The computer-implemented method of any of clauses 1-9, further comprising modifying the observational data based on the first positivity violation to generate a modified set of observational data that does not include the first positivity violation.

11. In some embodiments, one or more non-transitory computer-readable media include instructions that, when executed by one or more processors, cause the one or more processors to perform the steps of generating, using a trained machine learning model, a plurality of propensity scores based on observational data associated with a group of entities, wherein, for each entity included in the group of entities, the observational data includes a plurality of attribute values associated with the entity, and wherein the group of entities comprises a subset of first entities that received a treatment and a subset of second entities that did not receive the treatment; analyzing the plurality of propensity scores to identify one or more potential positivity violations; performing one or more training operations on the observational data based on the one or more potential positivity violations to generate a first trained decision tree associated with the one or more potential positivity violations; and determining, based on the trained first decision tree, a first positivity violation comprising a first combination of attribute values that is associated with at least one entity included in the subset of first entities and is not associated with any entity included in the subset of second entities.

12. The one or more non-transitory computer-readable media of clause 11, wherein the trained machine learning model is trained to receive one or more attribute values associated with an entity and determine a likelihood that the entity received the treatment.

13. The one or more non-transitory computer-readable media of clause 11 or clause 12, wherein analyzing the plurality of propensity scores comprises: generating a first propensity score distribution based on a first subset of propensity scores associated with the subset of first entities and a second propensity score distribution based on a second subset of propensity scores associated with the subset of second entities; and comparing the first propensity score distribution with the second propensity score distribution.

14. The one or more non-transitory computer-readable media of any of clauses 11-13, wherein analyzing the plurality of propensity scores comprises: generating a plurality of histogram bins based on the plurality of propensity scores; for each histogram bin included in the plurality of histogram bins: determining a first number of propensity scores included in the histogram bin that correspond to the subset of first entities and a second number of propensity scores included in the histogram bin that correspond to the subset of second entities; and comparing the first number of propensity scores and the second number of propensity scores to determine whether the histogram bin includes a positivity violation.

15. The one or more non-transitory computer-readable media of any of clauses 11-14, further comprising generating, for each data point included in the observational data, a corresponding label indicating whether the data point is associated with a positivity violation based on the one or more potential positivity violations.

16. The one or more non-transitory computer-readable media of any of clauses 11-15, wherein the first decision tree is trained to identify one or more attribute values included in the observational data that are associated with the one or more potential positivity violations.

17. The one or more non-transitory computer-readable media of any of clauses 11-16, wherein each node of the first decision tree is associated with one or more data points included in the observational data, and wherein performing the one or more training operations comprises pruning the first decision tree based on a percentage of data points included in a first node that correspond to the one or more potential positivity violations.

18. The one or more non-transitory computer-readable media of any of clauses 11-17, wherein each node of the first decision tree is associated with one or more data points included in the observational data, and wherein performing the one or more training operations comprises pruning the first decision tree based on a percentage of data points that correspond to the one or more potential positivity violations that are included in a first node.

19. The one or more non-transitory computer-readable media of any of clauses 11-18, wherein the first trained decision tree is associated with the subset of first entities, and wherein the steps further comprise: performing the one or more training operations on the observational data based on the one or more potential positivity violations to generate a second trained decision tree associated with the one or more potential positivity violations and the subset of second entities; and determining, based on the trained second decision tree, a second positivity violation comprising a second combination of attribute values that is associated with at least one entity included in the subset of second entities and is not associated with any entity included in the subset of first entities.

20. In some embodiments, a system comprises one or more memories storing instructions; and one or more processors that are coupled to the one or more memories and, when executing the instructions, perform the steps of: generating, using a trained machine learning model, a plurality of propensity scores based on observational data associated with a group of entities, wherein, for each entity included in the group of entities, the observational data includes a plurality of attribute values associated with the entity, and wherein the group of entities comprises a subset of first entities that received a treatment and a subset of second entities that did not receive the treatment; analyzing the plurality of propensity scores to identify one or more potential positivity violations; performing one or more training operations on the observational data based on the one or more potential positivity violations to generate a first trained decision tree associated with the one or more potential positivity violations; and determining, based on the trained first decision tree, a first positivity violation comprising a first combination of attribute values that is associated with at least one entity included in the subset of first entities and is not associated with any entity included in the subset of second entities.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for detecting positivity violations within a dataset, the method comprising:
generating, using a trained machine learning model, a plurality of propensity scores based on observational data associated with a group of entities, wherein, for each entity included in the group of entities, the observational data includes a plurality of attribute values associated with the entity, and wherein the group of entities comprises a subset of first entities that received a treatment and a subset of second entities that did not receive the treatment;
analyzing the plurality of propensity scores to identify one or more potential positivity violations;
performing one or more training operations on the observational data based on the one or more potential positivity violations to generate a first trained decision tree associated with the one or more potential positivity violations; and
determining, based on the trained first decision tree, a first positivity violation comprising a first combination of attribute values that is associated with at least one entity included in the subset of first entities and is not associated with any entity included in the subset of second entities.

2. The computer-implemented method of claim 1, wherein the trained machine learning model is trained to receive one or more attribute values associated with an entity and determine a likelihood that the entity received the treatment.

3. The computer-implemented method of claim 1, wherein analyzing the plurality of propensity scores comprises dividing the plurality of propensity scores into a first subset of propensity scores associated with the subset of first entities and a second subset of propensity scores associated with the subset of second entities.

4. The computer-implemented method of claim 1, wherein analyzing the plurality of propensity scores comprises:
generating a plurality of histogram bins based on the plurality of propensity scores; and
identifying at least one histogram bin that includes one or more propensity scores associated with the subset of first entities and does not include one or more propensity scores associated with the subset of second entities.

5. The computer-implemented method of claim 1, wherein analyzing the plurality of propensity scores comprises:
generating a plurality of histogram bins based on the plurality of propensity scores; and
identifying at least one histogram bin that includes one or more propensity scores associated with the subset of second entities and does not include one or more propensity scores associated with the subset of first entities.

6. The computer-implemented method of claim 1, further comprising:
performing one or more statistical analysis operations on the one or more potential positivity violations to determine a significance associated with each potential positivity violation included in the one or more potential positivity violations; and
wherein performing one or more training operations on the observational data is further based on the significance determined for each potential positivity violation included in the one or more potential positivity violations.

7. The computer-implemented method of claim 1, wherein each node included in the first decision tree corresponds to a different attribute included in the observational data and is associated with a subset of observational data that includes one or more attribute values for the corresponding attribute.

8. The computer-implemented method of claim 7, wherein performing the one or more training operations comprises:
determining, for a first node included in the first decision tree, that a number of data points that are associated with the first node and correspond to the one or more potential positivity violations satisfies a threshold level; and
in response to determining that the number of data points satisfies the threshold level, selecting the first node as a leaf node of the first decision tree.

9. The computer-implemented method of claim 1, further comprising causing a visual representation of the first positivity violation to be displayed to a user via a graphical user interface.

10. The computer-implemented method of claim 1, further comprising modifying the observational data based on the first positivity violation to generate a modified set of observational data that does not include the first positivity violation.

11. One or more non-transitory computer-readable media including instructions that, when executed by one or more processors, cause the one or more processors to perform the steps of:
generating, using a trained machine learning model, a plurality of propensity scores based on observational data associated with a group of entities, wherein, for each entity included in the group of entities, the observational data includes a plurality of attribute values associated with the entity, and wherein the group of entities comprises a subset of first entities that received a treatment and a subset of second entities that did not receive the treatment;
analyzing the plurality of propensity scores to identify one or more potential positivity violations;
performing one or more training operations on the observational data based on the one or more potential positivity violations to generate a first trained decision tree associated with the one or more potential positivity violations; and
determining, based on the trained first decision tree, a first positivity violation comprising a first combination of attribute values that is associated with at least one entity included in the subset of first entities and is not associated with any entity included in the subset of second entities.

12. The one or more non-transitory computer-readable media of claim 11, wherein the trained machine learning model is trained to receive one or more attribute values associated with an entity and determine a likelihood that the entity received the treatment.

13. The one or more non-transitory computer-readable media of claim 11, wherein analyzing the plurality of propensity scores comprises:
generating a first propensity score distribution based on a first subset of propensity scores associated with the subset of first entities and a second propensity score distribution based on a second subset of propensity scores associated with the subset of second entities; and
comparing the first propensity score distribution with the second propensity score distribution.

14. The one or more non-transitory computer-readable media of claim 11, wherein analyzing the plurality of propensity scores comprises:
generating a plurality of histogram bins based on the plurality of propensity scores;
for each histogram bin included in the plurality of histogram bins:
determining a first number of propensity scores included in the histogram bin that correspond to the subset of first entities and a second number of propensity scores included in the histogram bin that correspond to the subset of second entities; and
comparing the first number of propensity scores and the second number of propensity scores to determine whether the histogram bin includes a positivity violation.

15. The one or more non-transitory computer-readable media of claim 11, further comprising generating, for each data point included in the observational data, a corresponding label indicating whether the data point is associated with a positivity violation based on the one or more potential positivity violations.

16. The one or more non-transitory computer-readable media of claim 11, wherein the first decision tree is trained to identify one or more attribute values included in the observational data that are associated with the one or more potential positivity violations.

17. The one or more non-transitory computer-readable media of claim 11, wherein each node of the first decision tree is associated with one or more data points included in the observational data, and wherein performing the one or more training operations comprises pruning the first decision tree based on a percentage of data points included in a first node that correspond to the one or more potential positivity violations.

18. The one or more non-transitory computer-readable media of claim 11, wherein each node of the first decision tree is associated with one or more data points included in the observational data, and wherein performing the one or more training operations comprises pruning the first decision tree based on a percentage of data points that correspond to the one or more potential positivity violations that are included in a first node.

19. The one or more non-transitory computer-readable media of claim 11, wherein the first trained decision tree is associated with the subset of first entities, and wherein the steps further comprise:
performing the one or more training operations on the observational data based on the one or more potential positivity violations to generate a second trained decision tree associated with the one or more potential positivity violations and the subset of second entities; and
determining, based on the trained second decision tree, a second positivity violation comprising a second combination of attribute values that is associated with at least one entity included in the subset of second entities and is not associated with any entity included in the subset of first entities.

20. A system comprising:
one or more memories storing instructions; and
one or more processors that are coupled to the one or more memories and, when executing the instructions, perform the steps of:
generating, using a trained machine learning model, a plurality of propensity scores based on observational data associated with a group of entities, wherein, for each entity included in the group of entities, the observational data includes a plurality of attribute values associated with the entity, and wherein the group of entities comprises a subset of first entities that received a treatment and a subset of second entities that did not receive the treatment;
analyzing the plurality of propensity scores to identify one or more potential positivity violations;
performing one or more training operations on the observational data based on the one or more potential positivity violations to generate a first trained decision tree associated with the one or more potential positivity violations; and
determining, based on the trained first decision tree, a first positivity violation comprising a first combination of attribute values that is associated with at least one entity included in the subset of first entities and is not associated with any entity included in the subset of second entities.
